(19) United States
(12) Patent Application Publication
(10) Pub. No.: US 2020/0206972 A1
(43) Pub. Date: Jul. 2, 2020

(54) METHODS OF MAKING MONOLITHIC STRUCTURES AND DEVICES AND MONOLITHIC STRUCTURES AND DEVICES MADE THEREFROM

(71) Applicant: Douglas Ray Sparks, Warren, IN (US)

(72) Inventor: Douglas Ray Sparks, Warren, IN (US)

(21) Appl. No.: 16/729,988

(22) Filed: Dec. 30, 2019

Related U.S. Application Data
(60) Provisional application No. 62/917,766, filed on Dec. 31, 2018.

(51) Int. Cl. B28B 1/00; B33Y 80/00; B22F 3/00

(52) U.S. Cl. CPC B28B 1/001; B33Y 10/00; B22F 3/008; B33Y 80/00

(57) ABSTRACT

A monolithic structure containing several physical structures with features in the size range of 0.1-5000 micrometers. At least one of the physical structures contains of 3-dimensional surfaces, at least one of which is curved. Further, at least two of the 3-dimensional surfaces have varying orientations with respect to an external surface of the monolithic structure. A method of making a monolithic structure. The method includes generating computer aided design (CAD) files suitable for additive manufacturing of physical structures required for a monolithic structure. Utilizing the generated CAD files and specified materials, the physical structures containing features in the size range of 0.1-5000 micrometers are fabricated by additive manufacturing, At least one of the physical structure has 3-dimensioal surfaces wherein at least one of the 3-dimensional surface is curved and at least two of which have varying orientations with respect to an external surface of the monolithic structure.

### CROSS-REFERENCE TO RELATED APPLICATIONS

The present U.S. patent application is related to and claims the priority benefit of U.S. Provisional Patent Application Ser. No. 62/917,766, filed Dec. 31, 2018, the contents of which are hereby incorporated by reference in their entirety into the present disclosure.

### TECHNICAL FIELD

The present disclosure generally relates to methods of making monolithic structures and electronic devices such as, but not limited to, electronic sensors and microfluidic devices. This disclosure also relates to such devices made form methods described and disclosed herein.

### BACKGROUND

This section introduces aspects that may help facilitate a better understanding of the disclosure. Accordingly, these statements are to be read in this light and are not to be understood as admissions about what is or is not prior art.

Complex micromachined sensors and microfluidic devices have traditionally required hundreds of silicon and glass wafer or substrate processing steps to form tubes, channels and cantilevers. These wafer processing steps include wet and plasma etching of the silicon or glass wafers, wafer to wafer bonding and photolithography steps to pattern the surface of the silicon and glass wafers repeatedly. When the wafer or wafer stack is completed it is sawed to singulate each sensor or sensor chip and then the sensing chips are epoxied or soldered to the system package. This epoxy or solder is a weak point for microfluidics since long exposure to hot corrosive liquids can degrade the epoxy or solder resulting in chip adhesion loss. Wafer to wafer bonding interfaces in tubes are prone to separation during pressure spikes, separating or leaking fluids. Furthermore, both silicon and glass have low fracture toughness and can break if used in high-pressure applications. The above mentioned deficiencies of the device fabrication process lead to catastrophic device failure and possibly release of hazardous chemicals.

Hence there is an unmet need for device fabrication methods that eliminate or minimize several fabrication steps of traditional nature and also eliminate or minimize processes such as epoxy and solder bonding that can have deleterious effect on the fabricate devices. It is also desirable to have devices that are more robust and inherently more reliable due to the process steps involved.

### SUMMARY

A monolithic structure is disclosed. The monolithic structure contains a plurality of physical structures forming a monolithic structure wherein the plurality of the physical structures contain features in the size range of 0.1-5000 micrometers, and wherein at least one of the plurality of the physical structure has a plurality of 3-dimensional surfaces, wherein at least one of the 3-dimensional surface is curved, and wherein at least two of the plurality of 3-dimensional surfaces have varying orientations with respect to an external surface of the monolithic structure.

A method of making a monolithic structure is disclosed. The method includes generating computer aided design (CAD) files suitable for enabling additive manufacturing of a plurality physical structures forming the monolithic structure; and fabricating, by additive manufacturing utilizing the generated CAD files and a plurality specified materials, the plurality of physical structures, wherein the physical structures have features in the size range of 0.1-5000 micrometers, and wherein at least one of the plurality of the physical structure has a plurality of 3-dimensioal surfaces wherein at least one of the 3-dimensional surface is curved, and wherein the plurality 3-dimensional surfaces have varying orientations with respect to an external surface of the monolithic structure.

A technical effect of the disclosure is that monolithic structures suitable for electronic and microelectromechanical devices by utilizing such monolithic structures and methods of making them.

Another technical effect of this disclosure is that when electronic devices and microelectromechanical device are made by utilizing monolithic structures of the type described in this disclosure, reliability is enhanced since traditional joining methods such as epoxy bonding, solder bonding, and welding are avoided in the monolithic structures of this disclosure.

### BRIEF DESCRIPTION OF DRAWINGS

While some of the figures shown herein may have been generated from scaled drawings or from photographs that are scalable, it is understood that such relative scaling within a figure are by way of example, and are not to be construed as limiting.

FIG. 1 is a schematic representation of cross-sectional views of a monolithic structure showing a variety of surfaces and structures with different curvature and orientation with respect to the external surface of the monolithic structure.

FIGS. 2A through 2D are schematic representation of exemplary devices, which can employ tubes for fluidic applications, resonating tube, tubes and channels coupled to a flat surface for cooling as an active heat sink and cantilevers.

FIG. 3A through 3C are schematic representations of an array of devices in a round monolithic panel.

FIG. 3B shows an array of devices with patterned circuit layers on the top surface of the round monolithic panel utilizing the process and apparatus of this disclosure.

FIGS. 4A through 4C illustrate the fabrication and bonding together of two or more monolithic devices.

FIG. 5 is a schematic illustration of bonding of three devices together to form a differential capacitive pressure sensor.

FIG. 6 is a schematic representation of a 3D-printed monolithic device which includes a porous central volume encased in a solid shell container with an inlet and outlet both of which have a means of connecting into a pipeline.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

The present invention generally relates to certain electronic devices and methods of fabricating them. The devices of this disclosure are to be considered “monolithic”. For purposes of this disclosure, the term monolithic implies that there are no components that are bonded through such methods as epoxy bonding, welding and solder bonding. Instead, any such components that are traditionally bonded using such methods as epoxy bonding, welding and solder bonding are fabricated by 3D-printing to be part of the device. The monolithic device of this disclosure also has components and features and structures fabricated by traditional semiconductor device fabrication methods such as, but not limited to, photolithography, micromachining, plasma etching and other wafer fabrication methods. In some instances, the traditional semiconductor features can be found in or on the wafer which acts as the support on which the 3D-printed structures of the monolithic device are formed. The methods described in this disclosure begin with providing a support structure such as build plate (typically employed in additive manufacturing), on which components, features and structures are generated by a variety of fabrication methods including 3D printing. Such a build plate can be, but not limited to, a metallic wafer. For purposes of this disclosure 3D printing includes, but not limited to stereolithography (SLA) selective laser melting (SLM) or direct metal laser sintering (DMLS), Directed energy deposition (DED), laser metal deposition (LMD), Electron-beam melting (EBM), controlled electroplating and the printing of metal powder or metal compounds using a suspension of the powder and or compounds in a liquid polymer. Further, in this disclosure the terms 3D-printing and “additive manufacturing” are used interchangeably

It should be further noted that this disclosure relates to monolithic devices (and their fabrication) which have one or more internal and/or external structures with one or more surfaces of varying curvature and orientation with respect to a physical feature of the substrate or the device. It should be noted that in this disclosure the term “substrate” is used to designate a metal, glass or plastic panel upon which the three-dimensional structures described in this disclosure are fabricated via 3D printing or additive manufacturing processes.

Traditionally, various multi-angled machining, mechanical assembly processes, welding and casting methods can be used to form metal and plastic objects with channels, recesses, tubes, cantilevers and cavities of various orientations and angles. Forming monolithic devices with embedded cavities and channels of any angle by such methods (machining, welding and casting methods) becomes more difficult as the dimensions of these structures decreases below 1 millimeter.

Micromachining methods have been developed to fabricate small millimeter and micrometer structures in silicon and glass substrates with 3-dimensional complexity. Small sensors and microfluidic devices with structures that are curved or have multi-angled surfaces, have traditionally required hundreds of silicon and glass wafer processing steps to form tubes, channels and cantilevers shaped in the substrate. These wafer processing steps include wet and plasma etching of the silicon or glass wafers, wafer to wafer bonding and photolithography steps to pattern the surface of the silicon and glass wafers repeatedly. A single silicon fabrication step is somewhat limited in that it cannot form multiangled, rounded channels, tubes and curved cavity walls into a monolithic wafer. Many steps, such as photolithography, deposition and etching, are required to form a single structure in a silicon substrate. Only with multiple silicon patterning and etching steps can one form curved surface cavities, channels and cantilevers in a panel or wafer. Furthermore, the same type of photolithography steps coupled with film depositions can form patterned layers on the surface of the wafers. These layers can be dielectrics, metals and sensing layers. The deposited and patterned layers can act as electrical circuit elements or enhance wafer to wafer bonding through solder or adhesive attachment between the wafers. These micromachining manufacturing steps have been used to make silicon and glass pressure sensors, motion sensors, microfluidic devices like flow sensors, chemical sensors, density sensors, mixers, resonators as well as other sensors and actuators.

When the micromachined wafer to wafer stack is completed, the bonded stack of wafers is sawed to singulate each sensor and then the devices or sensing chips are often epoxied or soldered to the system package or tubing. This epoxy or solder is a weak point for microfluidics since long exposure to hot corrosive liquids can degrade the epoxy or solder resulting in chip adhesion loss. Wafer to wafer bonding interfaces in tubes are prone to separation during pressure spikes, or leaking fluids. Furthermore, both silicon and glass have low fracture toughness and can break if used in high-pressure applications. These potential problems limit the use of micromachined and bonded silicon and glass wafers in applications with hot, corrosive or high-pressure fluids.

In this disclosure, monolithic structures and devices, which include a variety of surfaces and structures with different curvature and orientation with respect to the external surface of the respective structures and devices, are described. The dimensions of some of the structures such as, but not limited to, walls, openings, diaphragm and channels can be in the range of 0.1 micrometers to more than 5000 micrometers. By using methods such as 3D-printing, all of these structures can be formed on a build plate used in additive manufacturing. 3D-printing methods are known to those skilled in the art and the state-of-the art for 3D printing allows for features in the size range of 0.1 micrometers to more than 5000 micrometers. The size of a feature is defined by the geometry of the feature. For example, for a via, it can be diameter of the via. For a channel it can be width, length or depth. For a tube it can be diameter and length of the tube. For a filament, it is the diameter or a cross-sectional parameter of the filament. Those skilled in the art will be able to interpret and understand “size of the feature” as used here in this disclosure. In additive manufacturing, a build plate is sometimes employed which acts as a support on which structures and circuitry can be built and the build plate is separated from the 3D-printed structures and/or circuitry formed. In some instances the build plate may not be separated as will be explained later in this disclosure The types of structures that can formed in the devices and structures include, but are not limited to, channels of any cross-sectional shape, straight as well as channels and tubes with bends, filaments, lattices of filaments, cantilevers, suspended tubes, cavities of any wall angle or curvature and diaphragms. These structures can be part of a variety of devices. By polishing at least one surface of the device electrical and sensing circuitry can be added. Bonding multiple devices together, including at least one 3D-printed device with embedded structures of varying curvature and orientation enhances the functionality of the device.

According to one aspect of the disclosure a microfluidic device can be formed and include tubes and channels embedded in a single monolithic device. The microfluidic device can include a cantilevered resonating tube attached to the frame of the chip. Circuitry attached to the tube or to an opposing substrate bonded to the microfluidic chip can drive the tube into resonance and additional circuitry on the device can sense the motion of tube. This device can measure the flow rate, density, viscosity and chemical concentration of the fluid moving through the channel and tube. In another variation of the invention the cantilever is solid and moves in response to external motion. This effect can be used to sense linear acceleration and angular rate and be used to generate electrical power in response to periodic external motion. Using wafer to wafer bonding these structures can be vacuum packaged to enhance the sensitivity of the resonant devices. By 3D-printing the device with a reactive metal and printing a porous high surface area cavity wall that can getter unwanted gas molecules from inside the cavity to lower the cavity pressure and further enhance the device performance.

According to another aspect of the disclosure, a microfluidic device can be formed wherein the device includes tubes and channels embedded in a monolithic device. The microfluidic device can include a tube or channel attached to or part of a planar surface of the chip and can act as a fluidic cooled heat sink. High thermal conductivity metals such as, but not limited to, copper and silver can be employed as well as corrosion resistant metals and alloys such as, but not limited to, titanium, Hastelloy® and stainless steels. In another design and fabrication variation, wafer device-to-device bonding to bond two monolithic devices can be used to form a three layered capacitive differential pressure sensor in which the fluid pushes against and moves a thin diaphragm. The motion of the central thin diaphragm with respect to the two adjacent electrodes gives an indication of pressure in the fluid. The two monolithic devices can each have 3D-printed structures such as several channel and cavity features.

According to another aspect of the disclosure, 3D-printing can be used to fabricate a monolithic microfluidic device containing a porous region surrounded by a solid shell having a fluid inlet and outlet. This monolithic device can filter particles, purify gases, act as a chemical catalyst or mitigate pressure surges in the fluid. Other variations of this concept include flat or curved monolithic panels with one or more porous surfaces, mount holes and in some cases circuits to heat the porous region as well as sense temperature, light and pressure. The 3D-printed panels can also include lighting elements for display and illumination applications.

Significant advantages of the present disclosure include a monolithic device with small 0.1 to 5000 micron feature sizes and internal and surface structures of multiple angles, curvature and orientation. According to this disclosure, these various structures in the monolithic device are fabricated.

The devices and methods of this disclosure will be better appreciated from the following descriptions along with references to the figures included in this disclosure.

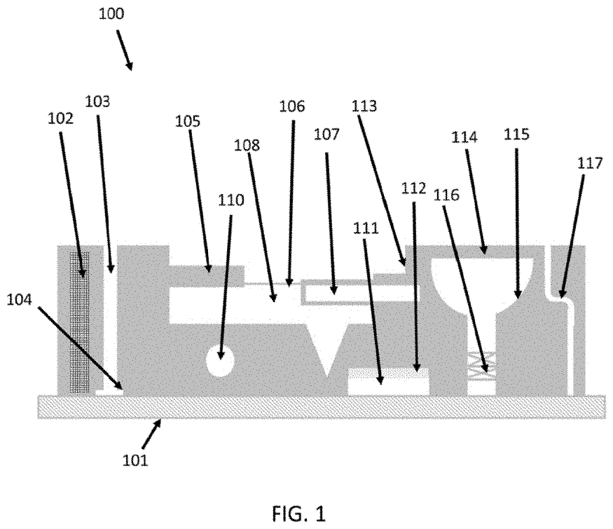

FIG. 1 is a schematic representation of cross-sectional views of a monolithic structure of this disclosure showing a variety of surfaces and structures with different curvature and orientation with respect to the external surface of the monolithic structure. FIG. 1 has several exemplary features fabricated according to the methods of this disclosure. Referring to FIG. 1, a monolithic structure 100, comprises a support 101 which acts as a support for subsequent 3D printing of structures and features as described in this disclosure. The structure 101 is also referred to as a build plate for many types of additive manufacturing methods. Thus in this disclosure the support on which 3D-printing steps are performed to generate a monolithic device of this disclosure is termed a build plate. In this disclosure the build plate 101 is typically made of a metallic or a non-metallic material. Examples of such metallic materials include, but not limited to titanium, zirconium, iron, cobalt and alloys of these and other metals. Examples of non-metallic materials to be used as build plate include plastics, ceramics, and non-metallic semiconductors. It should be noted that build plate 101 is optional for this disclosure as the additive manufacturing methods described later can be performed without the need for a build plate as known to those skilled in the art. Referring again to FIG. 1, 102 represents a channel with a lattice or filament network which can be a filter or getter or a low-density support structure for a saw street in between devices in an array; 103 represents a straight through-the-structure via for, as an example, an electrical or fluid path, when the build plate, 101, is removed, in a later process step, as described later in this disclosure, the via 103 will be open on both sides of the 3D-printed monolithic structure; 104 represents a recess at the surface exit of the via 103 to hold the end of a tube during connection to a microfluidic device, in a case where the monolithic structure is a microfluidic device; 105 represents a cantilever; 106 represents a filament or thin diaphragm support of a 3D printed cantilever, tube or other structure; The support filament may or may not be removed later in the manufacturing process as described later in this disclosure; 107 represents a suspended or cantilevered tube; 108 represents a cavity under a cantilever such as 105; 110 represents a channel in the panel, in this case with a round channel cross-section; 111 represents a cavity; when the build plate, 101, is removed, in a later process step, as described later in this disclosure, the cavity 111 will be open on one side of the monolithic structure. 112 represents a porous cavity wall or getter that can absorb gas impurities; 113 represents a cavity wall above a cantilever; 114 represents a diaphragm; 115 represents a curved cavity wall; 116 represents a through-structure via with a lattice or filament mesh that can act as a particle filter, getter gas absorber or pressure snubber; and 117 represents a curved through panel via or fluid path of any angle. It should be noted that a feature such as 117 cannot be formed in a conventional silicon MEMS wafer but can be formed using 3D printing. It should be further noted that the features described with reference to FIG. 1 are merely exemplary and many such features can be formed by the methods of this disclosure. Structures such as shown in FIG. 1 can be used to fabricate a variety of devices.

Further detail of some of the features shown in FIG. 1 is described below. The dimensions of the walls diaphragm 114 and channels 102, 103,116, 117 can be in the range of 0.1 to more than 5000 micrometers. Referring again to FIG. 1, channels or vias 103 through the entire thickness of the device 100 are illustrated, these vias often range in depth of from 10 to 5000 microns. These channels can be straight as 103 or have a bend as in 117. The channels and vias can also have a lattice of filaments 116 across the channel 102 for a variety of reasons including physical support during 3D printing, reducing the mass of the substrate, acting as a fluidic particle filter, absorbing impurities in a gas stream or reducing the severity of a pressure spike in the fluid. 3D-printing can utilize laser, ion beams, electron beams or arcs, selective electroplating to fuse the structure together and form the monolithic structure or device. An annular recess 104 can be formed where a surface of the monolithic structure intersects via 103 to accommodate the inserting of a tube. This tube can then be welded to the structure for a fluidic interconnection to an external system or package, if and as desired. The lattice filled channels and cavities 102 also speed the singulation of each device from the array of devices in the monolithic structure. When there is an array of devices in the monolithic structure from which individual devices are groups of devices are separated by singulation, the monolithic structure is referred to as a monolithic panel in this disclosure. This singulation can employ a mechanical saw, laser, wet etch or plasma etch. The lower mass density of the lattice filled region 102 will increase the etch or saw rate of the substrate in this region. The metallic materials used to make the structures (which can be sensing devices) of the monolithic structures or devices can include but not limited to: titanium, steel, stainless steel, 17-4PH, 17-7PH, corrosion resistant alloys and metals, Mo, Zr, Ti, Fe, Ni, W, alloys such as but not limited to brass, bronze, Kovar®, Hastelloy®, Invar® and other metals and alloys. Other materials beside metals such as but not limited to alloys, corrosion resistant alloys, glasses, ceramics and plastics can also be 3D-printed in the fabrication of the monolithic structures and devices of this disclosure.

Referring again to FIG. 1, FIG. 1 a solid cantilever 105 and hollow cantilever or tube 107 are depicted. A variety of devices employ cantilever to sense motion and mass such as accelerometers and gyroscopes as well as rely on motion to harvest energy as the cantilever resonates. Hollow tubes can be used as Coriolis mass flow sensors, density, mass, particle and cell counting sensors, chemical concentration and viscosity sensors. FIG. 1 shows a filament or thin diaphragm 106 joining the cantilever and tube together. Filaments and thin diaphragms can be used to provide physical support of a variety of structures during the 3D-printing process. This physical support reduces the chances of unwanted warpage, cracking and breaking that can occur during 3D-printing. A planar, thin diaphragm support enables the spinning of photoresist on the surface of a round panel in later post print processing. These support structures can be removed after printing, annealing and other post printing processing steps. The filaments or thin diaphragms 106, lattices 102 can be chemically etched away with a wet solution or plasma as well as mechanically, electrically, ionically or laser machined away. Oxidation or alloying of the substrate including the supporting filaments or thin diaphragm can enhance the selectivity of the removal of the supports. Titanium can be etched with solutions of hydrofluoric acid and a chlorine plasma. Plastic filaments can be etched with solvents and an oxygen plasma.

Referring again to FIG. 1, a diaphragm 114 is depicted which can be used to produce a pressure sensor. Sensing circuits can be patterned on the top surface of the diaphragm 114 and a fluid under test can interact with the backside of the diaphragm. The fluid under test would enter the channel which can have a filter made of filaments 116 in the channel. The filaments or lattice 116 can be dense enough to attenuate pressure spikes in the fluid, which will prevent rupture or deformation of the diaphragm 114.

Described below are several embodiments utilizing the concepts and methods of this disclosure. These embodiments are envisioned to be fabricated as monolithic structures utilizing 3D printing methods on a wafer or build plate as described above. It is to be understood that, while the structures are described stressing their function, the structures are fabricated utilizing 3D printing techniques on a metal panel and the metal panel is subsequently removed leaving the monolithic structure, monolithic device or a monolithic panel containing an array of devices behind.

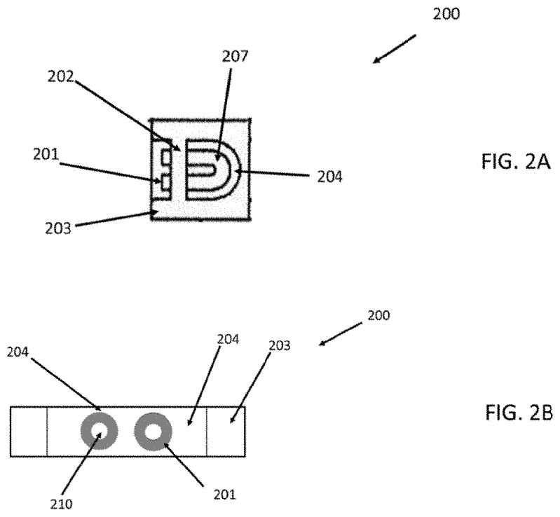

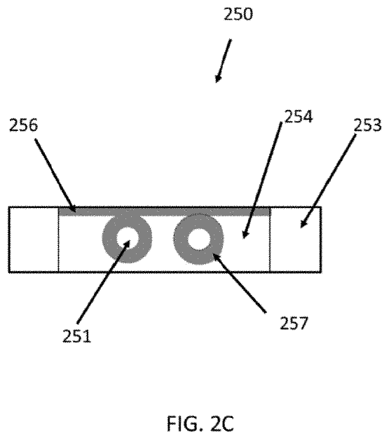

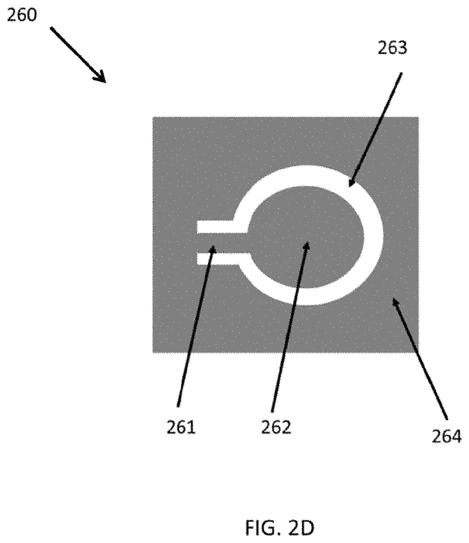

FIGS. 2A and 2B represent top view and edge on side view respectively of a device 200 which is a microfluidic device with tube and male tube inlet and outlet that employs a suspended tube 207 (similar to 107 shown in FIG. 1). The tube is anchored with section 202 to the frame 203 of the device 200 as shown in the top view of device 200 as depicted in FIG. 2A. A horizontal and vertical gap 204 is present between the device frame 203 and top and bottom surfaces to allow for motion of the tube. In this disclosure the word “frame” is used to denote areas where no functional element exists and the area merely serves to support the functional elements. A variation of the embodiment 200 employs a round channel cross-section 210 in the tube 207 with curved, round bends in the tube to reduce bubble nucleation and trapping when liquids are being tested. The tube 207 can be driven into resonance electrostatically, magnetically or via the piezoelectric effect. By sensing the frequency of the tube resonance the density of the fluid in the tube can be measured. Measuring the phase difference between the two sides of the tube can be used to measure the mass flow rate of the fluid passing through the tube using the Coriolis effect. Damping of the resonating tube can be employed to measure the viscosity of the fluid. Patterned circuit layers can be formed in the surface of the tube 207, or the device with the tube can be bonded to a second monolithic device and the surface of the second monolithic device can have capacitive sensing element. The ends of the tube can protrude from the side of the chip as shown by 201 in FIGS. 2A and 2B, and enable direct connection to external tubes via welding, brazing, epoxy or soldering. While FIG. 2A shows a U-shaped tube, other tube shapes like S, straight, parallel tubes and others are envisioned.

Thinner tube walls provide superior sensing performance for many applications. The interior resonating tube 207 shown in FIG. 2A can be 3D-printed and also formed from a deposited film. Examples of deposition methods include but are not limited to Chemical Vapor Deposition (CVD), Plasma Enhanced CVD and plating. Both the tube 207 and tubing inlet and outlets 201 can be 3D-printed. In an alternative embodiment the tube 207 can be formed from a thinner CVD layer while the inlet and outlet tube ends are a metal like titanium. This alternate device embodiment requires the coating of the channel with the film, forming the tube 207. A second deposition step can fill any holes in the first thin tube structure and metal or sensing layers can be deposited and patterned on the tube. This thin tube can be made of silicon nitride, silicon dioxide, polysilicon or tungsten as well as other materials. The device can be made of titanium, as an example. This alternate embodiment can have very thin walls (0.1 to 2 micrometer thick) walls for the resonant tube 207 walls but have thicker (outer diameter can be 0.5-2 millimeter) outer diameter titanium inlet and outlet tubes 201 on the device which can be welded to external tubing. This same type of dielectric film deposition process followed by device etching to undercut the dielectric layer, can be used to form thin insulating diaphragms to make devices like thermal flow sensors and gas sensors.

FIG. 2C shows an edge on side view of heat sink microfluidic device 250 which can be used to cool an attached device. FIG. 2C schematically represents how a thin planar diaphragm 256 can support tubes in the device 250 A gap 254 can be present between the tube 257 and frame 253. In the case of a heat sink device the planar surface 256 is attached to another device in need of cooling. Devices like but not limited to, microprocessors, amplifiers and switches generate heat and require cooling. These heat producing devices can be attached to the planar surface 256 of the microfluidic heat sink. A cooling fluid passes through the channels 250 and tubes 257 to remove heat. Meandering channels 250 can be located beneath the planar surface 256. Referring to FIG. 2C. If a resonating tube is desired the thin supporting diaphragm 256 can be removed. The device illustrated in FIG. 2C can also be employed as a heat sink. The flat surface, including the diaphragm 256 can be attached onto a device that requires active, fluidic cooling. The coolant can circulate through the channel 250 (250 is similar to the channel 110 in FIG. 1). The thin cooling device can be mounted onto devices like microprocessors, power integrated circuits, amplifiers and other electronics devices that generate heat.

FIG. 2D is a schematic representation of a device 260 utilizing a cantilever structure formed by 3D-printing on a build plate (build plate is not shown). A thin cantilever section 261 is lined between the frame of the device 264 and a mass 262. The mass 262 can be thicker than the thin cantilever 261. A gap 263 between the device frame 264 and mass 262 allows for motion of the cantilever in response to acceleration or movement of the device. A variety of devices employ a cantilever to sense motion and mass such as accelerometers and gyroscopes as well as rely on motion to harvest energy as the cantilever resonates. These motion sensors can be capacitive, piezoresistive, piezoelectric, magnetic and optical. The energy harvesting device can be capacitive or piezoelectric in this configuration. A capacitive device will require a second device, attached via device to device bonding, by methods known to those skilled in the art.

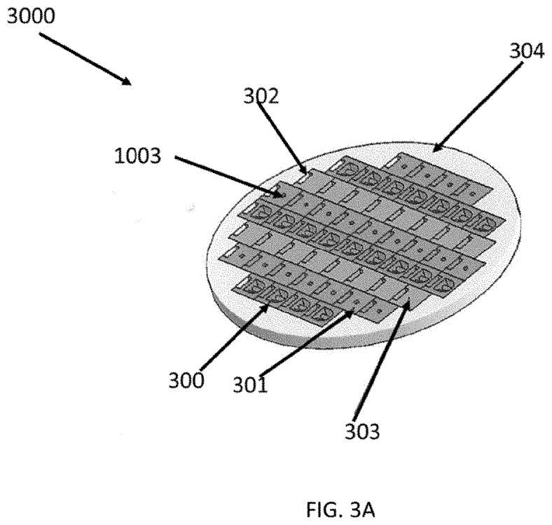

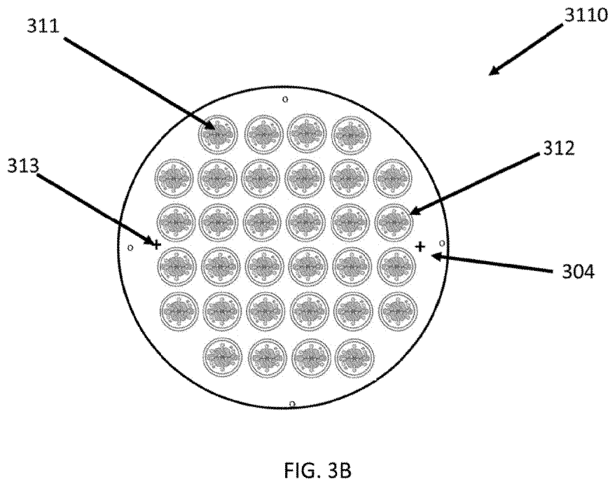

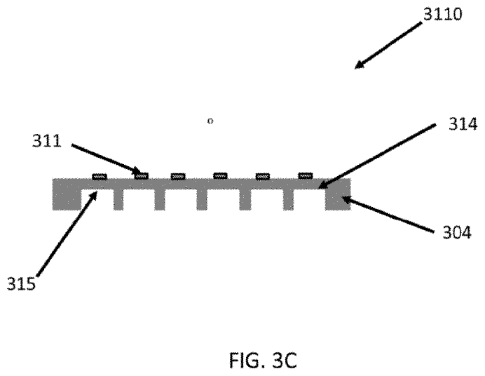

FIG. 3A through 3C are schematic representations of an array of devices in a round monolithic panel. As those skilled in the art know, these panels can be round, in which case they are often referred to as wafers, or rectangular. Round wafers typically have diameters ranging from 100 mm to 450 mm. The types of structures that can formed in the panel include, but are not limited to, channels of any cross-sectional shape, straight as well as channels and tubes with bends, filaments, lattices of filaments, cantilevers, tubes, cavities of any wall angle or curvature and diaphragms. The devices can later be singulated from the panel. A planar panel can also have circuit and sensing layers deposited and patterned on the surface of the wafer and each device. While the top surface of the panel can be planar, the backside and interior of the substrate can be a variety of curved surfaces and structures. When the panel processing is complete devices are singulated from the array using mechanical, laser or plasma dicing methods and the devices are separated from each other and the panel frame 304 is not occupied by devices and is removed after singulation. Such singulation processes are well known to those skilled in the art. FIG. 3A shows an example of three different types of devices being fabricated on a single monolithic panel 3000. Shown are several arrays; An array containing devices employing a U-shaped tube 300, an array containing devices including a top electrode 301 for a differential capacitive pressure sensor, and an array containing a capping device recess encloses the moving portions of the 303 is analogous to a chip-scale wafer level packaging. Capping device or structure 303 can use metals and thicknesses to shield devices from electromagnetic and ionizing radiation. Graded atomic number metal layers can provide enhanced shielding and can be 3D-printed with different metals, or the metal capping device can be electroplated or coated with other metals. Clear plastic and glass material can produce an optically or infrared transparent window for the capping structure 303. Referring to FIG. 3A, openings such as 302 through the monolithic panel allows for the metal wirebonding, round through panel vias allow for electrical and fluidic passage through the panel 1003. The panel shown in FIG. 3A can be formed using 3D-printing.

FIGS. 3B and 3C show a top view side view cross section respectively of a pressure sensor 3110. Referring to FIG. 3B, 304 is a planar surface. Referring to FIG. 3C, cavities 315 form a thin diaphragm 314 are shown. The thin diaphragm 314 support enables the spinning of photoresist on the surface of the round panel in later post print processing. Photomasks, screen printing, stencils, shadow masks, ink jet printing and 3d-printing can all be used to form the circuits on the substrate. The round shape of the panels with optional flats or notches, being of a diameter ranging from 100 mm to 450 mm can be processes on conventional silicon fabrication equipment. This enables thin film planar features to be formed on the polished surface of the monolithically 3D-printed panels to have dimensions across ranging from 5 nanometers to 500 micrometers with thicknesses ranging from 5 nanometers up to 10 micrometers. Fabrication commonly used for fiberglass or ceramic printed circuit boards and solar panels can also be applied to the 3D-printed monolithic panels to form circuit layers, in which case the panels can be rectangular in shape. The diaphragm can also be used to form a pressure sensor 312. After 3D-printing the top surface of the panels can be polished. Film deposition and patterning of dielectric layers like silicon dioxide or silicon nitride, piezoresistive layers like doped poly-silicon, amorphous silicon and other semi conductive films and metal can be applied to the smooth planar panel surface to form electrical circuits 311. While these semiconductor films such as silicon can used to form piezoresistive pressure, motion, strain and force sensors they can also be used to form photovoltaic solar cells and sensors. Photomasks can be used to form these patterns. An alignment key 313 can be 3D-printed or etched into the substrate. Once the circuit patterning is complete, the panel is sawn into individual pressure sensor devices 312. These devices can be welded onto a metal pressure sensor package.

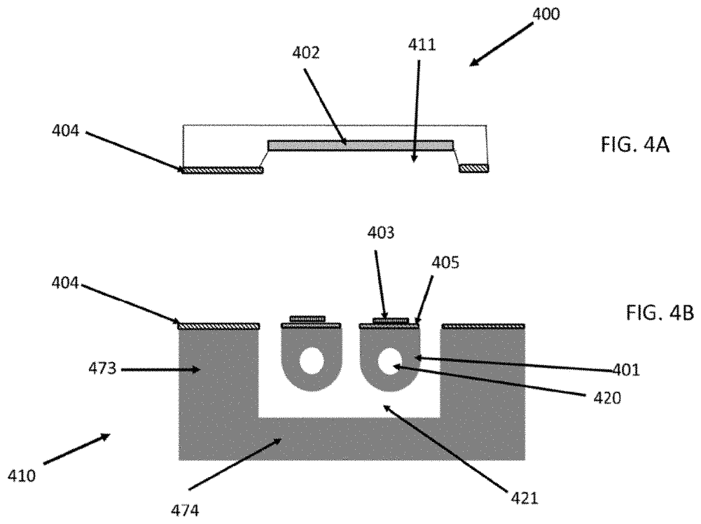

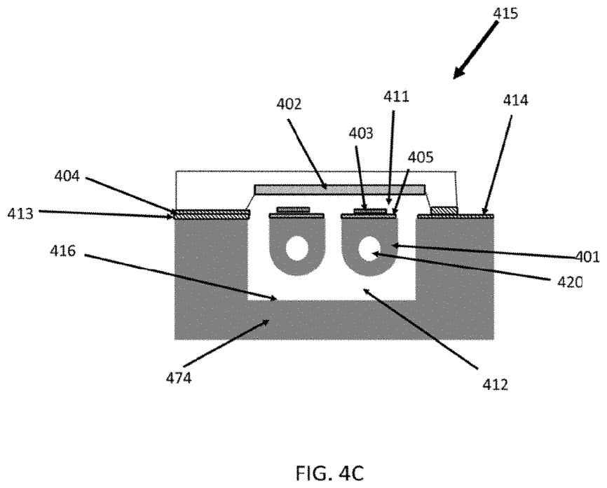

FIGS. 4A through 4C illustrate the fabrication and bonding together of two or more monolithic devices. Device to device bonding can join two monolithic devices into a more complex device.

FIG. 4A illustrates a cap 400, a monolithic device formed by the methods of this disclosure, with a porous getter 402 surface in the recessed cavity 411 and bonding surface 404. This is similar to cavity 111 in FIG. 1. FIG. 4B illustrates another monolithic device 410, which employs a bonding interface 404, parallel resonating tubes 401, with round cross-sectioned fluidic channels 420, similar to channel 110 in FIG. 1. A cavity 421 provides a space between the bottom of the tube 401 and the bottom of the device wall 474, to allow for vertical motion. Circuit layers 403 are formed on the tube consisting of a dielectric layer 405 and conductive or sensing layer 403. The tubes 401 in FIG. 4B and FIG. 4C are a cross-section, with the tubes being anchored to the frame 473 of the device similar to the tube shown in FIG. 2A and FIG. 2B. A bonding surface for 404 is also shown for attaching this device 410 to cap 400. The top surface of the tube 401 is flat and polished, allowing for the deposition and patterning of circuit elements. A dielectric layer 405 can electrically isolate the tube from the circuit elements 403. For Lorentz force actuated and sensed devices, these circuit elements 403 are just metal runners. Non-ferromagnetic materials like titanium are preferred for forming the device for Lorentz force sensors and actuators. Piezoelectric drive and sense elements as well as optically reflecting surfaces and capacitive electrodes can be formed on the tubes 401.

FIG. 4C illustrates the completed device after the cap 400 is bonded together to the resonating tube device 410, by joining the bonding surfaces 404 at the bonding interface 413. After bonding the cavity 411 can have a low pressure or vacuum 412. The material that the device 410 and cap 400 are made from can be a reactive metal like Ti, Fe or Zr or alloy. With such a reactive metal all cavity surfaces 416, which is part of the bottom device wall 474, and 402 will act as a getter to absorb gas molecules. Discrete devices and caps can be bonded together as can panels made up of an array of devices and capping cavities. Wirebonding to this device ship can occur at the bond pads 414 via the openings in the capping device 302. Bonding does not have to occur between two panels or wafers of the same material. Different materials can be bonded together if their thermal expansion coefficients are relatively close. Glass composition can be changed to vary their thermal expansion coefficients and match the opposing metal wafer. Anodic bonding can be used to join a glass wafer and metal wafers or panel assuming that their thermal expansion coefficients are close. The bonded panels can be fabricated in different manners such as machining, casting, 3d-printing and other wafer fabrication methods.

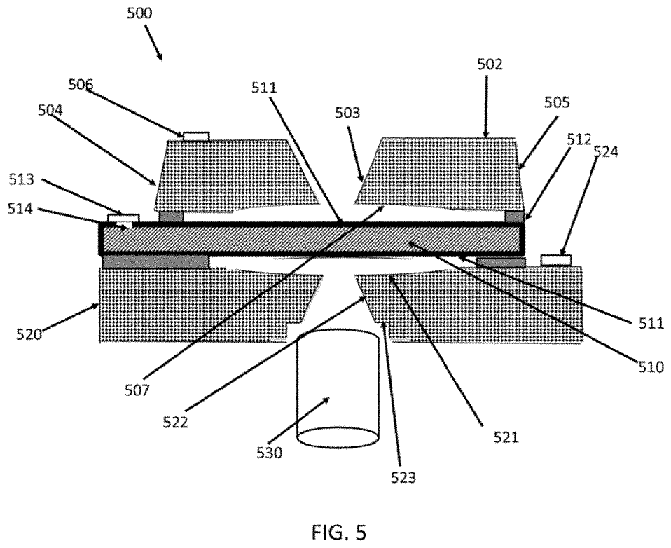

FIG. 5 illustrates how 3D-printing of two monolithic devices 502 and 520 to an insulated metal diaphragm 510 can be used to form a capacitive differential or gauge pressure sensor 500. FIG. 5 is a side view cross-section diagram of the capacitive pressure sensor. The top panel 502 has three through openings. Opening 503 is the top fluid port in the center of the device, allowing the fluid to reach the top surface of the diaphragm. Opening or via 504 allows access to the wire bond pad 513 of the diaphragm 510. Via opening 505 allows access to the wire bond pad of the bottom capacitor electrode 520. The wire bond pad for the top electrode is 506 on the top surface of the device. Both the top and bottom panels have spherically curved recesses 507 on top and 521 on bottom. Should a pressure spike hit the diaphragm, the diaphragm will be stopped by the curved recess wall 507 or 521, and not bend or rupture. The diaphragm 510 is coated with a dielectric layer 511 via deposition and thermal oxidation. To make electrical contact between the bond pad 513 and the diaphragm 510, the dielectric must be etched open 514. To make electrical contact with the bottom electrode 520, the diaphragm 510 must be etched away or a hole formed in the diaphragm prior to the bond pad 524 patterning. The diaphragm 510 can be a substrate that is thinned or foil. The three panels or two panels and foil can be bonded using with a material 512 such as an adhesive, glass, solder, eutectic or direct fusion bonding. An annular recess 523 is formed in the central through panel via 522 to seat a tube 530. This tube 530 is part of the system package that will supply fluid to the pressure sensor diaphragm 510. Tubing 530 can be welded on both sides of the pressure sensor 500.

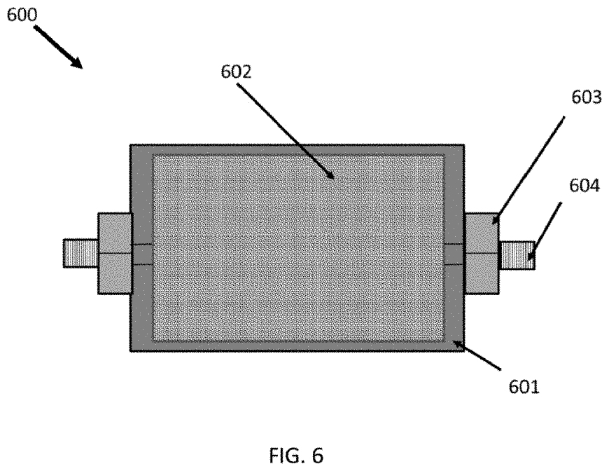

FIG. 6 is a diagram of a 3D-printed device 600 that can be used for fluid particle filtration, gas purification of unwanted molecules like a getter, catalytic reaction, gettering or pressure snubbing or pressure spike mitigation. The porous reactive getter material 602 is 3D-printed along with its container 601 and fittings for pipe or tubing connections. FIG. 6 shows a threaded male fitting 604 and hex nut 603, but female treaded fittings and welded fittings can be used. The central material for gettering and filtration can be a lattice of filaments 102 and 116, porous structure 402 or reactive metal powder isolated by a lattice of filaments containing the powder but letting the fluid flow through both the central powder area and two lattice containment sections at the inlet and outlet. By heating the device 600 and passing a reducing gas like hydrogen, through the heated device, the porous getter can be regenerated for improved chemical reactivity and long operational life. A variation of FIG. 6 includes a flat or curved panel with a porous surface 602. This panel can be attached into vacuum chambers to lower the pressure through gas molecule absorption. The panel can include circuits that heat the panel and getter 602 as well as circuits the sense temperature, pressure and light. The circuits can also accommodate display or lighting elements. Such getter panels can be employed in semiconductor equipment requiring vacuum, ion implanters, plasma etchers, particle accelerators, light and flat panel displays.

Described below is an exemplary method of this disclosure for making the monolithic structures, monolithic electronic devices and monolithic device panels of this disclosure. The method described here is merely illustrative of the major steps involved in the fabrication of the structures and devices of this disclosure. The purpose of this description is to illustrate the basic process flow and fundamental concepts of this disclosure and not to describe the detailed processes already known to those skilled in the art. In order to produce a monolithic structure, monolithic electronic device or a monolithic electronic device panel (containing an array of electronic devices), a computer aided design file suitable for enabling additive manufacturing of the desired structure, device, or panel is generated. A suitable build plate is then provided on which the desired structures, device, or panel is fabricated utilizing the CAD files and specified materials. It should be noted that a build plate is optional since 3D printing methods that do not require a build plate are known to those skilled in the art. The physical structures fabricated in the method of this disclosure have features in the size range of 0.1-5000 micrometers, and at least one of the plurality of the physical structure has a plurality of 3-dimensioal surfaces wherein at least one of the 3-dimensional surface is curved, and wherein at least two of the plurality 3-dimensional surfaces have varying orientations with respect to an external surface of the device. The build plate is then removed, resulting in the monolithic structures, monolithic electronic devices and monolithic device panels in conformance with the CAD files. As those skilled in the art know, the CAD process can include finite element modeling and the inclusion of support structures into the 3D printed device. Next a build plate on which the monolithic device or array of devices is to be 3D-printed. Typically, this build plate is a solid metal disc or panel of the same material to be printed; However. In some instances, it could be a more complex with circuits on the plate prior to the 3D printing step. As those skilled in the art know, after printing a part is typically annealed to reduce stress and then the build plate is removed (say, by cutting) cut from the monolithic 3D-printed device and the 3D-printed device is cleaned. Further, one or more surfaces of the 3D-printed structure, device or panel are polished. A CAD file of the circuit layers is used to create masks, screens or stencils for patterning thin film circuit layers that are applied to the polished surface of the monolithic device or panel. Then support structures such as filaments and thin diaphragms required to be removed are removed and the monolithic structure, device or panel is cleaned. At this point the device is complete or optionally another panel or cap can be bonded to the device or panel. In the case of an array of devices fabricated in a panel, the devices can be sawn from the array.

It should be recognized in certain instances the build plate may contain functional circuitry required for a given application, in which case the build plate is not separated from the monolithic structure formed on the build plate.

The monolithic structures, devices and panels of this disclosure can be 3D-printed using a variety of metals, alloys, plastics, glasses and ceramics which broadens the range of applications for the disclosure. By polishing at least one surface of the monolithic structure, device or panel electrical circuitry can be added and this planar surface can be bonded to other monolithic structures, devices or panels to enhance functionality. The electrodes and patterned layers 403, 405 on the top of tubes in FIG. 4B 4C as well as circuits 3110 shown in FIG. 3B can also be used on top of channels and tubes fabricated in plastic and glass panels. These can find applications in DNA analysis, electrophoresis, chemical, biological, medical, blood, saliva, urine and drug analysis, drug delivery, biofluid testing and sensing

Based on the above detailed description, it is an objective of this disclosure to disclose a monolithic structure containing serval physical structures which contain features in the size range of 0.1-5000 micrometers. At least one of the several physical structures has a plurality of 3-dimensional surfaces, and at least one of these 3-dimensional surfaces is curved. Further, in at least one physical structure, at least two of the plurality of 3-dimensional surfaces has varying orientations with respect to an external surface of the structure. Examples of physical structures contained in the monolithic structure include, but not limited to, a curved channel, a tube, a cantilever, a diaphragm, a filament connecting two surfaces, a lattice containing multiple filaments, and a cavity. In some embodiments of the disclosure, a monolithic structure can contain more than one physical structure with features and surfaces as described above.

In some embodiments of the monolithic structure of this disclosure, the physical structures are such that they are required for some devices such as, but not limited to a fluidic filter, a gas getter, a fluid pressure snubber, a fluidic mixer, a heat sink, and a micro-reaction chamber. In some embodiments of the monolithic structure described above, the physical structures are required for an electronic device. Examples of such electronic devices include, but not limited to, a microfluidic device, a pressure sensor, a temperature sensor, a chemical sensor, a biological sensor, and a fluid delivery device. In some embodiments of the monolithic structure, the physical structures include a tube through which a fluid can pass through, wherein the tube is capable of resonating, Some embodiments of the monolithic structure coating such as tube include, but not limited to, a Coriolis mass flow sensor, a fluid mass density sensor, a chemical concentration sensor, and fluid viscosity sensor. In some embodiments of the electronic device of this disclosure, the electronic device is a microelectromechanical device. Examples of such microelectromechanical devices include, but not limited to, an accelerometer, a gyroscope, an electrical switch, and an energy harvester.

It is another objective of this disclosure to describe a method of making a monolithic structure. The method includes, generating computer aided design (CAD) files suitable for enabling additive manufacturing of a plurality physical structures required for the monolithic structure. Utilizing the CAD files and several of the 3D-printing methods available several physical structures are fabricated using specified materials. The materials are specified for various reasons such as a physical or mechanical function, chemical function, electrical function, or an electronic function, to name a few. The 3D-printing is carried out such that the physical structures formed have features in the size range of 0.1-5000 micrometers, and at least one of the physical structures has one or more 3-dimensioal surfaces wherein at least one of the 3-dimensional surface is curved. Further, at least two of the 3-dimensional surfaces have varying orientations with respect to an external surface of the device. These physical structures as described above form the monolithic structure of this disclosure.

In some embodiments of the method described above, an additional polishing step is included by polishing at least one of the surfaces of the monolithic electronic device to result in at least one polished surface. In some embodiments, electronic circuit layers can be fabricated on such a polished surface.

In some embodiments of the method, the monolithic structure formed can be an electronic device or array electronic devices forming a panel. Examples of such electronic devices include but not limited to a microfluidic device, a pressure sensor, a temperature sensor, a chemical sensor, a biological sensor, and a fluid delivery device. In some embodiments of the method, the monolithic panel the physical structures may form an array of microelectromechanical devices. In some embodiments of the method, an additional process step can be included which is bonding a monolithic panel containing a plurality of the microelectromechanical devices to another electronic panel containing a different plurality of microelectromechanical devices.

In some embodiments of the method at least one of the specified materials is one of chemically reactive material, a catalytic material, and a porous chemically reactive material capable. Examples of such materials include, but not limited Pt, Ti, Zr, Pd, Fe, Co, C and alloys.

The method of claim 16, where in the microelectromechanical device is one of an accelerometer, a gyroscope, an electrical switch, and an energy harvester.

In some embodiments of the method, the at least one physical structure is one of a curved channel, a tube, a cantilever, a diaphragm, a filament connecting two surfaces, a lattice containing multiple filaments, a filament physically supporting another structure, and a cavity.

In some embodiments of the method, additional steps are included. Such additional steps include, but not limited to comprising and patterning layers in or on the monolithic structure or monolithic panel, where in the layers contain dielectrics, conductors, sensing, magnetic, resistive or optically reflective materials including but not limited to silicon nitride, aluminum nitride, silicon dioxide, metals, doped poly-silicon, amorphous silicon, graphene lead zirconia titanate, photoresist and polyimide on to form a tube or diaphragm connected to the monolithic structure or monolithic panel. Such patterning of the deposited layers on the 3D-printed surface printed surface can occur by etching.

It is another objective of this disclosure to describe a monolithic device made of a reactive material capable of absorbing gas molecules containing at least one wall to which is attached a surface of porous structures in sizes of 0.1 microns to 100 microns in width. It can be seen by those skilled in the art that such a device is a variation of the monolithic structure described above and the methods described above can be adapted by those skilled in the art to achieve such a device.

While the invention has been described in terms of specific embodiments, including particular configurations, it is apparent that other forms could be adopted by one skilled in the art. Accordingly, it should be understood that the invention is not limited to the specific disclosed embodiments. Other implementations are possible. Therefore, the scope of the invention is to be limited only by the following claims.

1. A monolithic structure comprising:
a plurality of physical structures forming a monolithic structure wherein the plurality of the physical structures contain features in the size range of 0.1-5000 micrometers, and wherein at least one of the plurality of the physical structure has a plurality of 3-dimensional surfaces, wherein at least one of the 3-dimensional surface is curved, and wherein at least two of the plurality of 3-dimensional surfaces have varying orientations with respect to an external surface of the monolithic structure.

2. The monolithic structure of claim 1, wherein the at least one of the plurality of the physical structures is one of a curved channel, a tube, a cantilever, a diaphragm, a filament connecting two surfaces, a lattice containing multiple filaments, and a cavity.

3. The monolithic structure of claim 1, where in the at least one of the plurality of the physical structure is a plurality of physical structures.

4. The monolithic structure of claim 1, wherein the plurality of the physical structures is physical structures required for an electronic device.

5. The monolithic structure of claim 4, wherein the at least one of the plurality of the physical structures is a tube through which a fluid can pass through, wherein the tube is capable of resonating,

6. The monolithic structure of claim 5, wherein the electronic device is one of a Coriolis mass flow sensor, a fluid mass density sensor, a chemical concentration sensor, and a fluid viscosity sensor.

7. The monolithic structure of claim 4, wherein the electronic device is one of a microfluidic device, a pressure sensor, a temperature sensor, a chemical sensor, a biological sensor, and a fluid delivery device.

8. The monolithic structure of claim 1, wherein the plurality of the physical structures are physical structures required for one of a fluidic filter, a gas getter, a fluid pressure snubber, a fluidic mixer, a heat sink, and a microreaction chamber.

9. The monolithic structure of claim 4, wherein the electronic device is a microelectromechanical device.

10. The monolithic structure of claim 9, wherein the microelectromechanical device is one of an accelerometer, a gyroscope, an electrical switch, and an energy harvester.

11. A method of making a monolithic structure, the method comprising;
generating computer aided design (CAD) files suitable for enabling additive manufacturing of a plurality physical structures required for a monolithic structure; and
fabricating, by additive manufacturing utilizing the generated CAD files and a plurality specified materials, the plurality of physical structures forming the monolithic structure, wherein the physical structures have features in the size range of 0.1-5000 micrometers, and wherein at least one of the plurality of the physical structure has a plurality of 3-dimensioal surfaces wherein at least one of the 3-dimensional surface is curved, and wherein at least two of the plurality 3-dimensional surfaces have varying orientations with respect to an external surface of the monolithic structure. resulting in a monolithic structure containing the plurality of the physical structures required for the monolithic structure.

12. The method of claim 10, further comprising the step of polishing at least one of the surfaces of the monolithic structure to result in at least one polished surface.

13. The method of claim 12, further comprising the step of fabricating electronic circuit layers on the at least one polished surface.

14. The method of claim 11, wherein the monolithic structure is an electronic device.

15. The method of claim 14, wherein the electronic device is an array containing a plurality of electronic devices, resulting in a monolithic panel containing the plurality of electronic devices.

16. The method of claim 15, further comprising bonding the monolithic panel containing the plurality of the microelectromechanical devices to another electronic panel containing a different plurality of microelectromechanical devices.

17. The method of claim 11, wherein at least one of the plurality of specified materials is one of chemically reactive material, a catalytic material, and a porous chemically reactive material capable.

18. The method of claim 10, wherein the electronic device is a microelectromechanical device.

19. The method of claim 16, where in the microelectromechanical device is one of an accelerometer, a gyroscope, an electrical switch, and an energy harvester.

20. The method of claim 10, wherein the at least one physical structure is one of a curved channel, a tube, a cantilever, a diaphragm, a filament connecting two surfaces, a lattice containing multiple filaments, a filament physically supporting another structure, and a cavity.
